(19) United States
(12) Patent Application Publication
(10) Pub. No.: US 2002/0017160 A1
(43) Pub. Date: Feb. 14, 2002

(54) Gear drive unit

(76) Inventors: Yoshihide Kiyosawa, Nagano-ken (JP); Yoshio Yamazaki, Nagano-ken (JP)

Correspondence Address: William C. Rowland, BURNS, DOANE, SWECKER & MATHIS, L.L.P., P.O. Box 1404, Alexandria, VA, 22313-1404, US

(21) Appl. No.: 09/899,841

(22) Filed: Jul. 9, 2001

(30) Foreign Application Priority Data
Jul. 13, 2000 (JP) P-2000-212120

(51) Int. Cl. F16H 35/00

(52) U.S. Cl. 74/640

(57) ABSTRACT

A wave gear drive unit 1 has an annular housing 2 and a wave reduction gear mechanism 3 placed inside the housing 2. The wave reduction gear mechanism 3 has a cup-shaped flexible external gear 6 which serves as an output element of the unit and is rotatably supported on the housing 2 via a cross roller bearing 4. An outer race 11 of the bearing 4 is screwed to the housing 2. Whereby, it is possible to suppress deformation of the outer ring and uneven axial-force distribution thereof which may occur when a number of fastening bolts are used to fasten the outer race to the housing. Assembling and processing operations can also be simplified, thereby reducing the manufacturing cost. The unit can also be made small and compact since the space for mounting the fastening bolts is eliminated.

### BACKGROUND OF THE INVENTION

1. Field of the Invention

This invention relates to a gear drive unit having an annular housing, a reduction gear mechanism such as a wave gear reduction mechanism and the like accommodated in the housing, and a bearing for rotatably supporting an output shaft of the reduction gear mechanisme, and in particular to improvement in mounting the bearing on the annular housing thereof.

2. Related Art Description

FIG. 3 shows a wave gear drive unit of this type. The wave gear drive unit 100 shown in this figure has an annular housing 101, a wave reduction gear mechanism 102 accommodated in the housing 101, and a cross roller bearing 103 which rotatably supports a reduced-speed output element of the wave reduction gear mechanism 102 on the housing 101. The wave reduction gear mechanism 102 has a rigid circular internal gear 104 fixed on the inner circumferential surface of the housing 101, a cup-shaped flexible external gear 105 disposed inside the internal gear 104, and an elliptical-shaped wave generator 106 fixed into the external gear 105.

The cross roller bearing 103 has an outer race 108 fixed on the housing end surface 107, an inner race 110 fixed on a boss 109 of the external gear 105, and a plurality of rollers 111. The inner race 110 serves as an output flange, and a load-side member (not shown) is fixedly connected to an outer end surface of the inner race 110. Whereas, the outer race 108 is fastened to the housing end surface 107 by means of a plurality of fastening bolts 114 screwed into bolt holes which are formed in the housing end surface 107 and penetrate through the outer race 108.

In such a structure that the fastening bolts 114 are used to fix the outer race 108 to the housing end surface 107, the outer race must be prevented from being deformed by the fastening bolts, and at the same time, axial force distribution along a circumferential direction must be equalized. Otherwise, such defects may occur that the lifetime of the cross roller bearing is shortened, rotational accuracy is degraded or the like. In order to avoid these defects, a number of small-sized fastening bolts are used to suppress deformation of the outer race and to equalize the axial force distribution along the circumferential direction thereof.

However, since a number of fastening bolts are used, drilling and tapping operations of the outer race and housing are increased, assembling steps are also increased, and therefore the manufacturing cost becomes high. Further, the outer race and housing end surface must be increased in diameter for assuring a space for placing a number of fastening bolts, which causes the wave reduction gear unit to enlarge.

### SUMMARY OF THE INVENTION

Accordingly, a main object of this invention is to realize a gear drive unit in which an outer race of a bearing for supporting an output shaft can be fixed on a housing without deformation or uneven axial-force distribution of the outer race.

Another object of this invention is to realize a gear drive unit which can be manufactured at a low cost and with a less number of assembling and processing steps.

In order to solve the above and other objects, according to this invention, there is provided a gear drive unit comprising:

an annular housing;

a reduction gear mechanism accommodated in the housing; and

a rolling bearing for rotatably supporting an output member of the reduction gear mechanism on the housing;

wherein the rolling bearing has an outer race mounted on the housing, an inner race mounted on the output member and a plurality of rollers, and

wherein the outer race is formed on its outer circumferential surface with an external thread portion and the housing is formed on its inner circumferential surface with an internal thread portion meshable with the external thread portion, the outer race being screwed into and fixed to the housing.

In the gear drive unit of this invention, since the outer race of the rolling bearing is screwed and fixed to the housing, the outer race hardly suffers from deformation or uneven axial-force distribution along a circumferential direction which may occur in a case where a number of fastening bolts are used. Further, since the fastening bolts are not used, the number of steps in assembling and processing such as of drilling can be reduced, thereby lowering the manufacturing cost. In addition, the space for placing fastening bolts is not needed, and by that amount, the diameter of the outer race and the housing can be reduced, whereby the unit can be made small and compact.

It is preferable that the housing is formed with a circular stepped surface which comes in contact with a circular end surface of the outer race when the outer race is screwed to the housing. With this surface to surface contact between these two members, the outer race can be assembled to the housing with a high accuracy.

It is also preferable that, when viewed along a unit axial line, a center of the rollers is positioned between a screwed portion of the outer race into the housing and a contact portion of the outer race to the housing. Where this structure is adopted, deformation of the outer race can be suppressed, and therefore this structure is particularly preferable when a thin outer race is used.

In order to prevent the screwed portion of the outer race to the housing from loosening, it is preferable to provide a loosening prevention mechanism. For example, adhesive may be used to adhere the screwed portion. Or, a spring element is inserted between the external and internal thread portions constituting the screwed portion. Alternatively, the external and internal thread portions may be deformed plastically.

It is preferable that the outer race is formed on its outer circumferential surface or end surface with engagement projections or recesses which are used to the outer race to screw to the housing with a sufficient driving torque.

On the other hand, the inner race and the flexible external gear can be fastened by screw fitting. In this case, the inner race may be formed on its inner circumferential surface with an internal thread portion and the output member may be formed on its outer circumferential surface with a external thread portion which is meshable with the internal thread portion.

As the rolling bearing, a cross roller bearing and a four-point contact ball bearing can be used, for example.

This invention can be applied to a wave gear drive unit having a wave gear mechanism as the reduction gear mechanism, wherein a flexible external gear is the output element and has a boss to which the inner race is mounted. In this case, the boss is formed on its outer circumferential surface with an external thread portion and is screwed into an internal thread portion formed on an inner circumferential surface of the inner race.

### BRIEF DESCRIPTION OF THE DRAWINGS

FIGS. 1A and 1B are sectional and end views of a wave gear drive unit according to this invention,

FIG. 2 is a partial sectional view of the wave gear drive unit of FIG. 1, showing a portion where a cross roller bearing is mounted in an enlarged scale, and

FIGS. 3A and 3B are sectional and end views of a conventional wave gear drive unit.

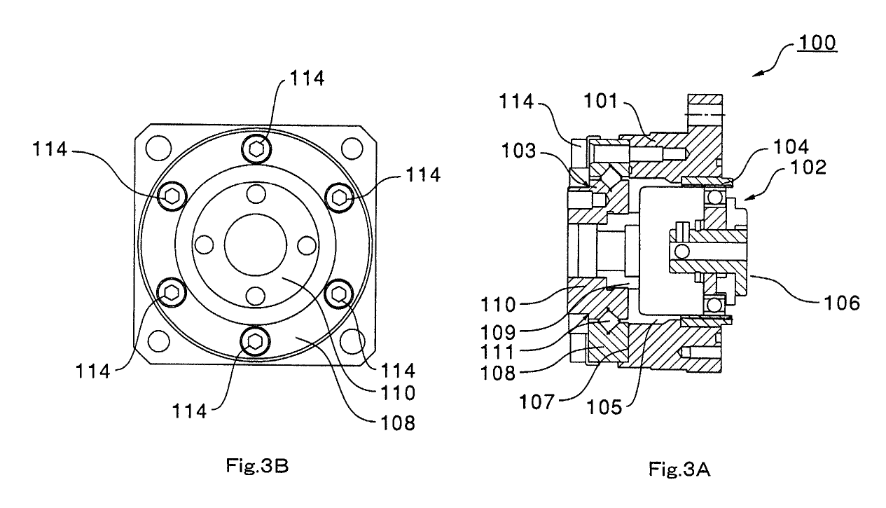

### DETAILED DESCRIPTION OF THE PREFERRED EMBODIMENT

An example of a wave gear drive unit according to this invention will now be described in detail with reference to the drawings.

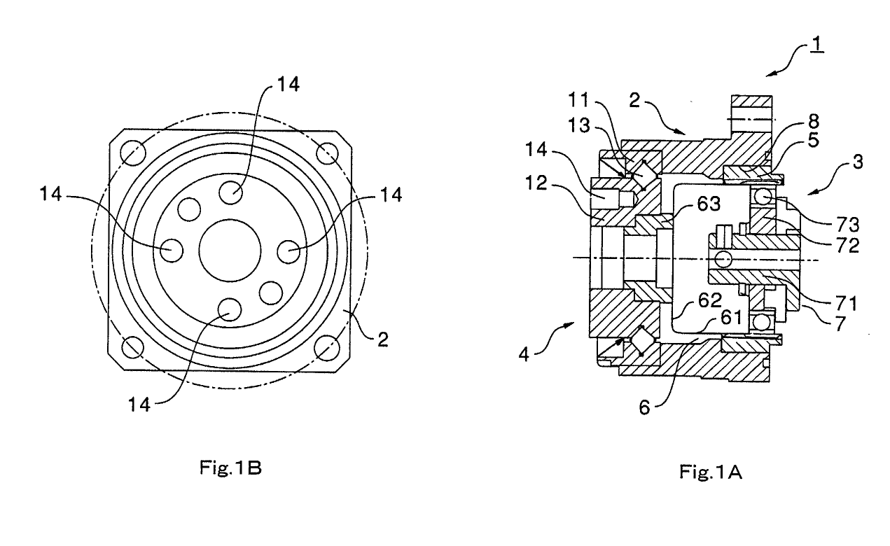

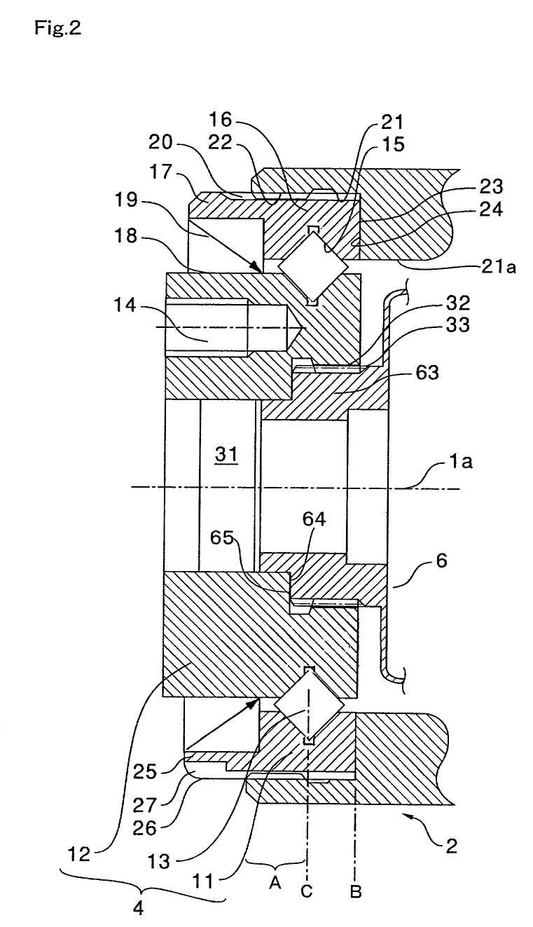

FIGS. 1A and 1B are sectional and end views of a wave gear drive unit of this example, respectively. FIG. 2 is a partial sectional view of the wave gear drive unit, showing a portion where a cross roller bearing is mounted in an enlarged scale. The wave gear drive unit 1 of this example has an annular housing 2, a wave reduction gear mechanism 3, and a cross roller bearing 4 for rotatably supporting an output element of the wave reduction gear mechanism 3 on the housing 2.

The wave reduction gear mechanism 3 has a circular rigid internal gear 5, a cup-shaped flexible external gear 6 as the output element thereof, and an elliptical-shaped wave generator 7. The rigid internal gear 5 is fixedly fitted into a circular stepped portion 8 formed on an inner circumferential surface of the housing 2. The cup-shaped flexible external gear 6 has an annular body 61, a circular diaphragm plate 62 extending radially and inwardly from an end of the body 61, and a circular boss 63 integrally formed on an inner peripheral edge of the diaphragm plate 62. The wave generator 7 has a hollow input shaft 71 into which an input shaft of high rotational speed of a motor or the like is fixedly inserted, a rigid cam plate 72 having an elliptical shape fixed on the hollow input shaft 71, and a wave bearing 73 fixed on an outer circumferential surface of the rigid cam plate 72.

While, the cross roller bearing 4 has an outer race 11 mounted on the housing inner circumferential surface, an inner race 12 mounted on an outer circumferential surface of the boss 63 of the flexible external gear 6, and a plurality of rollers 13 which are arranged in a circular race defined by the outer and inner races 11, 12 in a manner that their rotational axes are perpendicular with each other one by one along a circumferential direction. In this example, the inner race 12 serves as an output flange connected to a load-side member (not shwon), and is formed on its outside end surface with screw holes 14 at a constant angular interbal along a circumferential direction.

Next, the portion where the cross roller bearing 4 is mounted will be explained in detail with reference mainly to FIG. 2. The outer race 11 has a circular body portion 16 which is formed on its inner ciurcumferential surface with a outer race surface 15 having a V-shaped section, and a circular thin projected portion 17 which is formed by projecting only an outer circumferential side portion of the outer-side circular end surface of the body portion 16 along the unit axial line 1a. A circular oil seal 19 is inserted between the circular projected portion 17 and the outer circumferential surface 18 of the inner race 12.

In this example, an external thread portion 20 is formed on a region from the outer circumferential surface of the body portion 16 to the outer circumferential surface of the circular projected portion 17. The housing 2 is formed on its one open end portion with an inner circumferential surface portion 21 having a diameter larger than that of adjacent inner circumferential surface portion 21a. On the open end side portion of this inner circumferential surface portion 21, there is formed an inner thread portion 22 meshable with the external thread portion 18. The outer race 11 is screwed and fixed to the open end portion of the housing 2 in a condition that the circular end surface 23 at the inner side of the outer race 11 is in contact with the circular stepped surface 24 of the housing side. Thus, surface to surface contact can be established, so that the outer race 11 can be assembled to the housing 2 with a high accuracy.

The circular projected portion 17 of the outer race 11 is formed on its outer circumferential surface 26 with a plurality of engagement recesses 27 at a constant angular interval along a circumferential direction. Each engagement recess 27 extends from the outside end surface 25 to the approximately middle portion of the circular projected portion 17 along its axial direction. The engagement recesses 27 are used when the outer race 11 is screwed to the housing 2 in such a manner that a fastening tool is engaged with two or more engagement recesses 27 to rotate the outer race 11 with a sufficient fastening torque for secure fastening of the outer race 11. Instead of forming the engagement recesses 27, engagement projections may be formed.

On the other hand, in this example, when viewed along the unit axial line 1a, the center point C of the rollers 13 is located between the screwed portion A where the outer race 11 is screwed to the housing 2 and the contact portion B where the circular end surface 23 is contacted with the circular stepped surface 24. With this arrangement being adopted, deformation of the outer race 11 can be suppressed. Especially, this arrangement is effective where the outer race 11 is thin.

The inner race 12 and the external gear 6 are also connected by means of screw fitting. Namely, the circular inner race 12 has a center through hole 31 whose inner end side portion has a diameter larger than the remaining hole portion. This large diameter portion is formed on its inner circumferential surface with an internal thread portion 32. The boss 32 is formed on its outer circumferential surface with an external thread portion 33 which can be meshed with the inner thread portion 32. The center through hole 31 has a circular stepped surface 64 which is in surface to surface contact with a circular end surface 65 formed on the boss 63, whereby assembling accuracy of these parts can be improved.

Further, in this example, adhesive is applied to the screwed portion between the outer race 11 and the housing 2, and is also applied to that between the inner race 12 and the boss 63 of the flexible external gear, so that loosening of these screwed portions can be prevented. Instead, the loosening prevention mechanism can be made by plastically deforming these threaded portions or by inserting a spring member between these threaded portions.

Instead of the cross roller bearing, a ball bearing such as a four-point contacted ball bearing can be employed. It is of course to say that the other type rolling bearing can be employed.

In addition, this invention can be applied to a gear drive unit having a reduction gear mechanism other than the wave reduction gear mechanism.

As mentioned above, according to this invention, the rolling bearing for rotataby supporting the output shaft on the housing is screwed to the housing. Therefore, in comparison to the case where a number of fastening bolts are used to fasten the outer race to the housing, deformation of the outer race and uneven axial-force distribution thereof can be suppressed. Further, since the fastening bolts are not used, it is possible to reduce the number of assembling and processing steps, thereby lowering the manufacturing cost. In addition, a space for placing fastening bolts is not needed, and therefore the diameter of the outer race and the housing can be reduced, whereby the unit can be made small and compact.

Further, the housing is formed with a circular stepped surface which comes in contact with a circular end surface of the outer race when the outer race is screwed into the housing. With this surface to surface contact between these two members, the outer race can be assembled to the housing with a high accuracy.

In addition, when viewed along a unit axial line, a center of the rollers is positioned between the screwed portion of the outer race to the housing and the contact portion of the outer race to the housing. Where this structure is adopted, deformation of the outer race can be suppressed, and therefore this structure is particularly preferable when the outer race is thin.

What is claim is:

1. A gear drive unit comprising:
an annular housing;
a reduction gear mechanism accommodated in the housing; and
a rolling bearing for rotatably supporting an output member of the reduction gear mechanism on the housing;
wherein the rolling bearing has an outer race mounted on the housing, an inner race mounted on the output member and a plurality of rollers, and
wherein the outer race is formed on its outer circumferential surface with an external thread portion and the housing is formed on its inner circumferential surface with an internal thread portion meshable with the external thread portion, the outer race being screwed to the housing.

2. A gear drive unit according to claim 1, wherein
the housing is formed with a circular stepped surface which is in contact with a circular end surface of the outer race.

3. A gear drive unit according to claim 2, wherein
when viewed along a unit axial line, a center of the rollers is positioned between a screwed portion where the outer race is screwed to the housing and a contact portion where the outer race is in contact with the housing.

4. A gear drive unit according to claim 1, further comprising a loosening prevention means for preventing a screwed portion between the outer race and the housing from loosening.

5. A gear drive unit according to claim 4, wherein
the loosening prevention means is adhesive applied between the external and internal thread portions, or a spring member inserted therebetween.

6. A gear drive unit according to claim 4, wherein
the loosening prevention means is formed by plastically deforming the external and internal thread portions.

7. A gear drive unit according to claim 1, wherein
the outer race is formed on its outer circumferential surface or its end surface with engagement projections and/or engagement recesses which are used when the outer race is screwed to the housing.

8. A gear drive unit according to claim 1, wherein
the inner race is formed on its inner circumferential surface with an internal thread portion, and the output member has an outer circumferential surface formed with an external thread portion which is meshable with the internal thread portion, the output member being screwed to the inner race.

9. A gear drive unit according to any one of claims 1 to 8, wherein
the rolling bearing is a cross roller bearing or a four-point contacted ball bearing.

10. A wave gear drive unit comprising:
an annular housing,
a wave reduction gear mechanism accommodated in the housing, and
a rolling bearing for rotatably supporting a cup-shaped flexible external gear of the wave reduction gear mechanism on the housing,
wherein the flexible external gear has an annular body, a circular diaphragm plate extending radially and inwardly from one end of the body, and a boss integrally formed on an inner peripheral edge of the diaphragm plate,
wherein the rolling bearing has an outer race mounted on the housing, an inner race mounted on the boss and a plurality of rollers, and
wherein the outer race is formed on its outer circumferential surface with an external thread portion and the housing is formed on its inner circumferential surface with an internal thread portion meshable with the external thread portion, the outer race being screwed to the housing.

11. A gear drive unit according to claim 10, wherein
the housing is formed with a circular stepped surface which is in contact with a circular end surface of the outer race.

12. A gear drive unit according to claim 11, wherein
when viewed along a unit axial line, a center of the rollers is positioned between a screwed portion where the outer race is screwed to the housing and a contact portion where the outer race is in contact with the housing.

13. A gear drive unit according to claim 10, further comprising a loosening prevention means for preventing a screwed portion between the outer race and the housing from loosening.

14. A gear drive unit according to claim 13, wherein
the loosening prevention means is adhesive applied between the external and internal thread portions, or a spring member inserted therebetween.

15. A gear drive unit according to claim 13, wherein
the loosening prevention means is formed by plastically deforming the external and internal thread portions.

16. A gear drive unit according to claim 10, wherein
the outer race is formed on its outer circumferential surface or its end surface with engagement projections and/or engagement recesses which are used when the outer race is screwed to the housing.

17. A gear drive unit according to claim 10, wherein
the inner race is formed on its inner circumferential surface with an internal thread portion, and the flexible external gear has an external thread portion formed on an outer circumferential surface of the boss, the boss being screwed to the inner race.

18. A gear drive unit according to any one of claims 10 to 17, wherein
the rolling bearing is a cross roller bearing or a four-point contacted ball bearing.
